(19) United States
(12) Patent Application Publication
(10) Pub. No.: US 2009/0013097 A1
(43) Pub. Date: Jan. 8, 2009

(54) METHOD AND RELATED INTEGRATED CIRCUIT FOR DYNAMICALLY CONFIGURING USB ENDPOINT RESOURCE

(76) Inventors: Fu-Yuan Hsiao, Hsinchu (TW); Chuan-Hsin Wu, Hsinchu (TW); Shih-Tsung Kuo, Hsinchu (TW); Han-Bin Yang, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 11/876,763

(22) Filed: Oct. 22, 2007

(30) Foreign Application Priority Data
Jul. 5, 2007 (TW) 096124530

(51) Int. Cl. G06F 13/00

(52) U.S. Cl. 710/16

(57) ABSTRACT

A method for dynamically configuring USB endpoint resource includes providing a USB endpoint resource having a plurality of endpoint access units, detecting and determining a total number of a plurality of USB endpoints and characteristics of each USB endpoint, portioning out the plurality of endpoint access units for use by each USB endpoint.

### BACKGROUND OF THE INVENTION

1. Field of the Invention

The present invention relates to a method and related integrated circuit for dynamically configuring USB endpoint resource, and more particularly, to a method and related integrated circuit for dynamically configuring the USB endpoint resource according to a total number of the plurality of USB endpoints and the characteristics of each USB endpoint.

2. Description of the Prior Art

Universal serial bus (USB) is a connection interface researched and planned out by the main leaders of the science and technology industry, such as Compaq, Digital, IBM, Intel, Microsoft, NEC and Northern Telecom, which is provided with characteristics like ease of use, good expandability, plug-and-play (PnP), and high-speed data transfer. USB has become a common computer connection interface standard, whereof its operation speed has developed from an initial speed of 12 Mbps to 480 Mbps since its introduction in 1995, and users can find its application in a variety of electronic products. Due to the advantages of higher transmission speed and plug—and play, numerous products in the market support the USB standard interface and USB has become a general trend; as common as mice, keyboards, card readers, digital cameras, external flash memory cards, external hard disks, etc.

The number of demanded USB endpoints and the characteristics of each USB endpoint for different USB products are not exactly the same according to different applications. In some cases, the USB endpoints need only a “transmitting” or “receiving” function; in other cases, the USB endpoints must have the “transmitting” and “receiving” functions at the same time.

Only one endpoint access unit is needed for “transmitting” or “receiving” data for a USB endpoint that needs only one of the “transmitting” or “receiving” functions at any one time. Two endpoint access units are needed for a USB endpoint that must have both the “transmitting” and “receiving” functions at the same time, whereof one endpoint access unit is used for “transmitting” data and the other one is used for “receiving” data. If an integrated circuit is to be applied to all USB applications and USB products, then theoretically all the USB endpoints must be provided with the “transmitting” and “receiving” functions. Please refer to FIG. 1, which is a diagram of a USB integrated circuit 10 according to the prior art. The USB integrated circuit 10 includes a USB endpoint resource having 2M endpoint access units EAU₀-EAU_{(2M-1)}, whereof each two endpoint access units are provided for each USB endpoint. For example, the endpoint access units EAU₀ and EAU₁ are provided for the use of the first USB endpoint EP₀, and the endpoint access units EAU₂ and EAU₃ are provided for the second USB endpoint EP₁, and so fourth. However, not all the USB endpoints must have both the “transmitting” and “receiving” functions at the same time.

As shown in FIG. 1, the first USB endpoint EP₀ must have the “transmitting” and “receiving” functions at the same time, the USB endpoints EP₁ and EP₂ need the “receiving” function only, and the USB endpoint EP₃ needs the “transmitting” function only, and so fourth. Hence, the statuses of these two endpoint access units EAU₀ and EAU₁ provided for the first USB endpoint EP₀ are both “in use”, the statuses of the two endpoint access units EAU₂ and EAU₃ for the second USB endpoint EP₁ are respectively “in use” and “idle”, the statuses of the two endpoint access units EAU₄ and EAU₅ provided for the third USB endpoint EP₂ are respectively “in use” and “idle”, and statuses of the two endpoint access units EAU₆ and EAU₇ for the fourth USB endpoint EP₃ are respectively “idle” and “in use”, and so fourth. In this embodiment, within totally 2M endpoint access units, only (M+1) endpoint access units are actually used and the other (M−1) endpoint access units are unused.

Because each endpoint access unit EAU occupies IC layout area, too many unused endpoint access units will waste the IC area and relatively increase the production cost of IC circuits. Hence, in order to lower the production cost of the IC circuits, there are some products with fixed USB endpoint resource configuration appeared. Please refer to FIG. 2. FIG. 2 is a diagram of a USB integrated circuit 20 according to the prior art. The USB integrated circuit 20 includes a USB endpoint resource having (M+1) endpoint access units EAU₀-EAU_{M}, wherein each endpoint access unit is immovably provided for the usage of a certain USB endpoint. For example, except for the first USB endpoint EP₀ is assigned with two endpoint access units EAU₀ and EAU₁, the other USB endpoints EP₁-EP_{(M-1)} in the following are assigned with one endpoint access unit (EAU₂-EAU_{M} are assigned in order). In this embodiment, the M USB endpoints EP₀-EP_{(M-1)} only need (M+1) endpoint access units EAU₀-EAU_{M}. Therefore, no excess IC area is wasted. This kind of design is suitable for some specific applications, but not all the USB applications. For example, if the USB endpoint EP₃ needs to have the “transmitting” and “receiving” functions at the same time for only some applications, this IC circuit can not be applied to those kinds of applications.

Because the number of the USB endpoints and the characteristics of each USB endpoint are different for different USB products, the design in FIG. 1 can satisfy all applications but has the disadvantage of wasting IC area and increasing IC cost. Although the design in FIG. 2 won't increase excess IC area, it can only be used in specific applications, which restricts the use and the flexibility of IC circuits.

### SUMMARY OF THE INVENTION

Therefore, it is one of the objectives of the claimed invention to provide a method and related integrated circuit for dynamically configuring USB endpoint resource.

The claimed invention provides a method for dynamically configuring USB endpoint resource. The method includes providing a USB endpoint resource, wherein the USB endpoint resource includes a plurality of endpoint access units, detecting and determining a total number of a plurality of USB endpoints and characteristics of each USB endpoint, and portioning out the plurality of endpoint access units for usages of each USB endpoint according to the total number of the plurality of USB endpoints and the characteristics of each USB endpoint. Each one of the endpoint access units is utilized for transmitting data or receiving data. The method further includes determining whether or not the USB endpoint is a transmitting endpoint, a receiving endpoint, or a transmitting and receiving endpoint.

The claimed invention provides an integrated circuit for dynamically configuring USB endpoint resource. The integrated circuit includes a USB endpoint resource, a detection and judgment unit, and a configuration unit. The USB endpoint resource includes a plurality of endpoint access units, wherein each one of the endpoint access units is used for transmitting data and receiving data. The detection and judgment unit is used for detecting and determining a total number of a plurality of USB endpoints and characteristics of each USB endpoint. The configuration unit is coupled to the detection and judgment unit for portioning out the plurality of endpoint access units for usages of each USB endpoint according to the total number of the plurality of USB endpoints and the characteristics of each USB endpoint. When the USB endpoint is a transmitting endpoint, portioning out one endpoint access unit for the usage of the transmitting endpoint. When the USB endpoint is a receiving endpoint, portioning out one endpoint access unit for the usage of the transmitting endpoint. When the USB endpoint is a transmitting and receiving endpoint, portioning out two endpoint access units for the usage of the transmitting and receiving endpoint.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a USB integrated circuit according to the prior art.

FIG. 2 is a diagram of a USB integrated circuit according to the prior art.

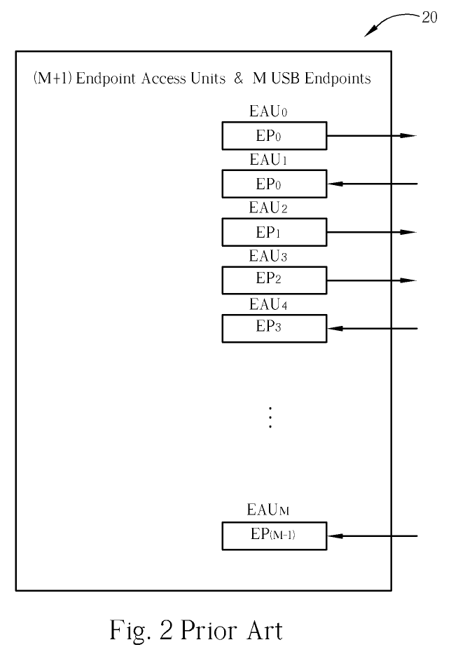

FIG. 3 is a flow chart of a method for dynamically configuring the USB endpoint resource according to an embodiment of the present invention.

FIG. 4 is a diagram of a USB integrated circuit for dynamically configuring the USB endpoint resource according to an embodiment of the present invention.

FIG. 5 is a diagram of a USB integrated circuit for dynamically configuring the USB endpoint resource according to another embodiment of the present invention.

FIG. 6 is a diagram of a USB integrated circuit for dynamically configuring the USB endpoint resource according to another embodiment of the present invention.

FIG. 7 is a diagram of a USB integrated circuit for dynamically configuring the USB endpoint resource according to another embodiment of the present invention.

FIG. 8 is a diagram of a USB integrated circuit for dynamically configuring the USB endpoint resource according to another embodiment of the present invention.

FIG. 9 is a diagram of a USB integrated circuit for dynamically configuring the USB endpoint resource according to another embodiment of the present invention.

### DETAILED DESCRIPTION

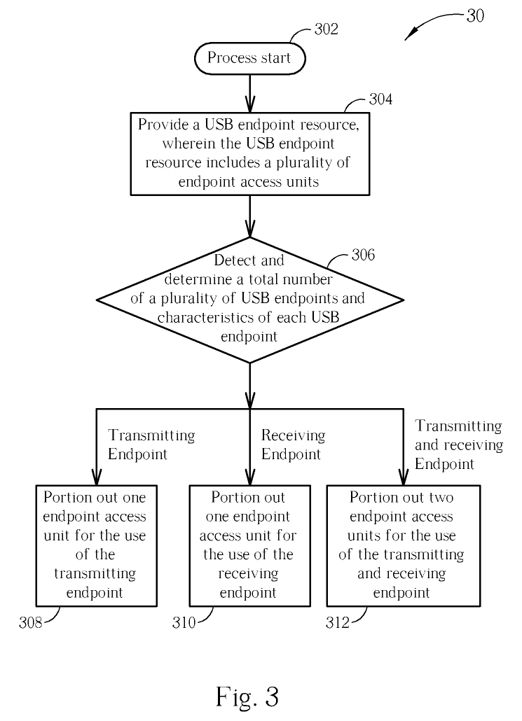

Please refer to FIG. 3. FIG. 3 is a diagram of a process flow 30 of a method for dynamically configuring the USB endpoint resource according to an embodiment of the present invention. The process flow 30 includes the following steps:

Step 302: Process start.

Step 304: Provide a USB endpoint resource, wherein the USB endpoint resource includes a plurality of endpoint access units.

Step 306: Detect and determine a total number of a plurality of USB endpoints and characteristics of each USB endpoint. If the USB endpoint is a transmitting endpoint, process goes to Step 308; if the USB endpoint is a receiving endpoint, process goes to Step 310; if the USB endpoint is a transmitting and receiving endpoint, process goes to Step 312.

Step 308: Portion out one endpoint access unit for the use of the transmitting endpoint.

Step 310: Portion out one endpoint access unit for the use of the receiving endpoint.

Step 312: Portion out two endpoint access units for the use of the transmitting and receiving endpoint.

In the step 304, the USB endpoint resource includes the plurality of endpoint access units, wherein each endpoint access unit is used for transmitting data or receiving data. In the step 306, the total number of the plurality of USB endpoints and the characteristics of each USB endpoint will be detected, and then different characteristics and different number of the endpoint access units will be portioned out in Steps 308-312 according to the detection result. For example, if the USB endpoint is a transmitting endpoint, one endpoint access unit is portioned out for the use of the transmitting endpoint (Step 308), whereof the endpoint access unit portioned out for the use of the transmitting endpoint is used for transmitting data. If the USB endpoint is a receiving endpoint, one endpoint access unit is portioned out for the receiving endpoint (Step 310), whereof the endpoint access unit portioned out for the usage of the receiving endpoint is used for receiving data. If the USB endpoint is a transmitting and receiving endpoint, two endpoint access units are portioned out for the usage of the transmitting and receiving endpoint (Step 312), whereof one endpoint access unit portioned out for the usage of the transmitting and receiving endpoint is used for transmitting data and the other one is used for receiving data.

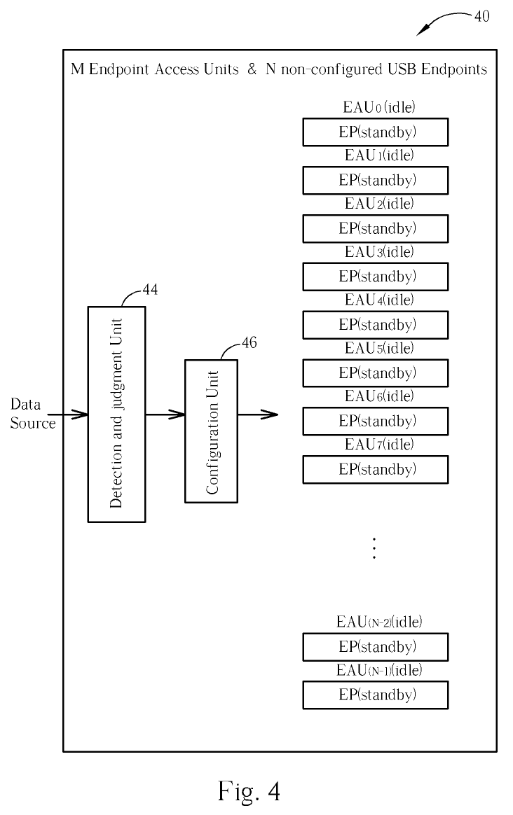

Please refer to FIG. 4. FIG. 4 is a diagram of an integrated circuit 40 for dynamically configuring the USB endpoint resource according to an embodiment of the present invention. The integrated circuit 40 for implementing dynamic configuration of the USB endpoint resource includes a detection and judgment unit 44, a configuration unit 46, and a USB endpoint resource. The USB endpoint resource includes N endpoint access units EAU₀-EAU_{(N-1)}, wherein each endpoint access unit is used for transmitting data or receiving data. The detection and judgment unit 44 is used for detecting and judging the total number of USB endpoints and the characteristics of each USB endpoint. The configuration unit 46 is coupled to the detection and judgment unit 44 and to the USB endpoint resource for portioning out the N endpoint access units EAU₀-EAU_{(N-1)} for the use of each USB endpoint according to the detection result of the detection and judgment unit 44. This embodiment is a state before dynamical configuring the USB endpoint resource, wherein all of the N endpoint access units EAU-EAU_{(N-1)} are waiting to be configured and are in “idle” status.

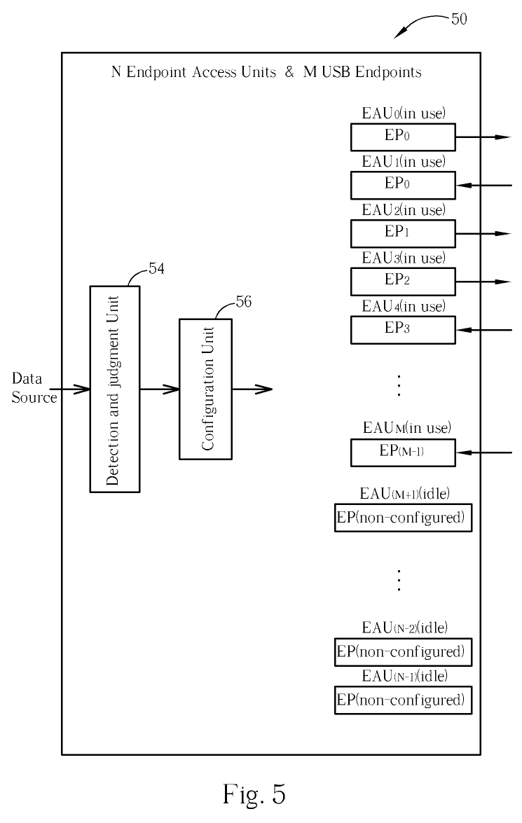

Please refer to FIG. 5. FIG. 5 is a diagram of an integrated circuit 50 for dynamically configuring the USB endpoint resource according to another embodiment of the present invention. The integrated circuit 50 includes a detection and judgment unit 54, a configuration unit 56, and a USB endpoint resource. Each device and its function in FIG. 5 and in FIG. 4 are the same, and no more detail description is provided herein. The USB endpoint resource includes N endpoint access units EAU₀-EAU_{(N-1)}. In this embodiment, there are in total M USB endpoints EP₀-EP_{(M-1)}, wherein the first USB endpoint EP₀ is a transmitting and receiving endpoint, the USB endpoints EP₁ and EP₂ are each a transmitting endpoint, and the USB endpoint EP₃ is a receiving endpoint, and so fourth. Hence, the configuration unit 56 will portion out two endpoint access units EAU₀ and EAU₁ for the use of the first USB endpoint EP₀, the configuration unit 56 will respectively portion out the endpoint access units EAU₂ and EAU₃ for USB endpoints EP₁ and EP₂, and the configuration unit 56 will portion out the endpoint access unit EAU₄ for the use of USB endpoint EP₃, and so fourth. Through the detection of the detection and judgment unit 54 and the configuration of the configuration unit 56, (M+1) endpoint access units EAU₀-EAU_{M} in total need to be portioned out for the usage of the M USB endpoints EP₀-EP_{(M-1)} and the other (N−M−1) endpoint access units EAU_{(M+1)}-EAU_{(N-1)} are idle. The data source of the detection and judgment unit 54 is obtained from outside the integrated circuit 50.

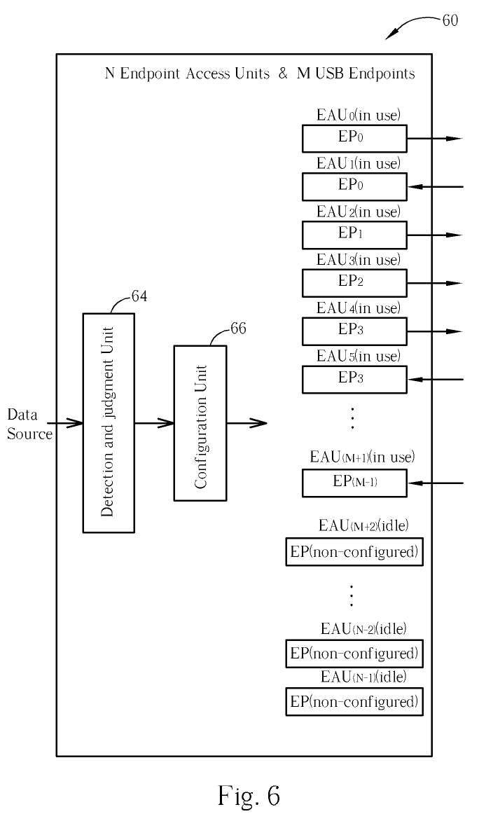

Please refer to FIG. 6. FIG. 6 is a diagram of an integrated circuit 60 for dynamically configuring the USB endpoint resource according to another embodiment of the present invention. The structure and the operating manner of the integrated circuit 60 are similar to that of the integrated circuit 40 in FIG. 4. Compared to FIG. 5, the difference is that the USB endpoint EP₃ in the integrated circuit 60 is a transmitting and receiving endpoint instead of a receiving endpoint. Therefore, the configuration unit 66 will portion out two endpoint access units EAU₄ and EAU₅ for the usage of the USB endpoint EP₃ instead of portioning out one endpoint access unit. Through the detection of the detection and judgment unit 64 and the configuration of the configuration unit 66, totally (M+2) endpoint access units EAU₀-EAU_{(M+1)} need to be portioned out for the use of the M USB endpoints EP₀-EP_{(M-1)} and the other (N−M−2) endpoint access units EAU_{(M+2)}-EAU_{(N-1)} are idle. As known from the examples in FIG. 5 and FIG. 6, through the disclosed design, the same integrated circuit can be applied to different applications even though the characteristics of the USB endpoints are different. Please note that, the data source of the detection and judgment unit 64 is obtained from outside the integrated circuit 60.

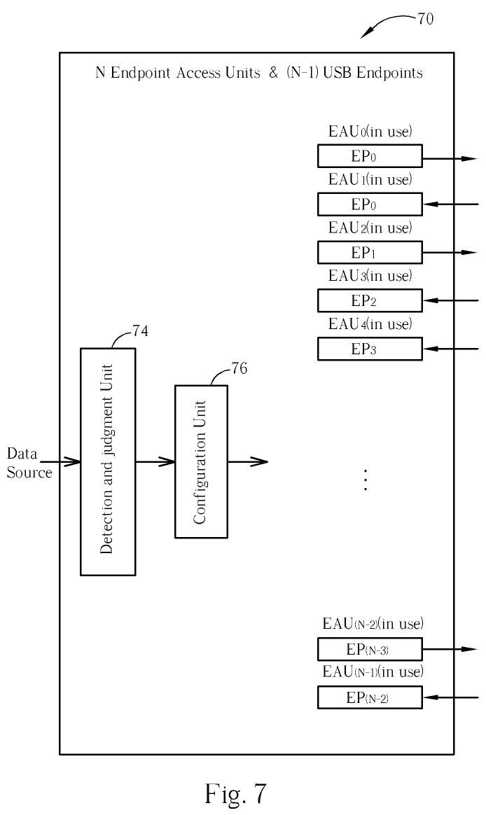

Please refer to FIG. 7. FIG. 7 is a diagram of an integrated circuit 70 for dynamically configuring the USB endpoint resource according to yet another embodiment of the present invention. The structure and operating manner of the integrated circuit 70 are similar to those of the integrated circuit 40 in FIG. 4. The difference between them is that there are totally (N−1) USB endpoints EP₀-EP_{(N-2)} included in the integrated circuit 70, whereof the first USB endpoint EP₀ is a transmitting and receiving endpoint, the USB endpoint EP₁ is a transmitting endpoint, and the USB endpoints EP₂ and EP₃ are each a receiving endpoint, and so fourth. Therefore, the configuration unit 76 will portion out two USB endpoint access units EAU₀ and EAU₁ for the usage of the first USB endpoint EP₀, the configuration unit 76 will portion out one USB endpoint access unit EAU₂ for the usage of the USB endpoint EP₁, the configuration unit 76 will respectively portion out the USB endpoint access units EAU₃ and EAU₄ for the usage of the USB endpoints EP₂ and EP₃, and so fourth. By the detection of the detection and judgment unit 74 and the configuration of the configuration unit 76, in total N endpoint access units EAU₀-EAU_{(N-1)} need to be portioned out for the usage of the (N−1) USB endpoints EP₀-EP_{(N-2)}. In this embodiment, the USB endpoint resource includes N endpoint access units, which is the case supporting a maximum number of endpoints.

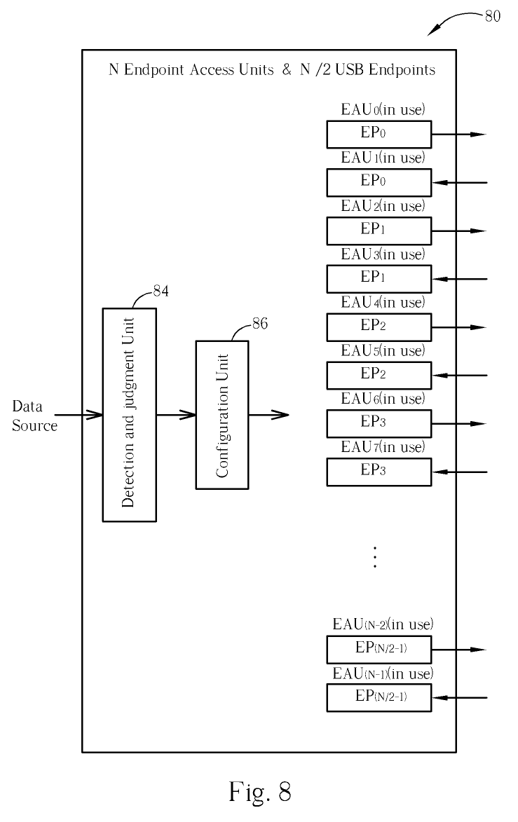

Please refer to FIG. 8. FIG. 8 is a diagram of an integrated circuit 80 for dynamically configuring the USB endpoint resource according to another embodiment of the present invention. The structure and the operating manner of the integrated circuit 80 are similar to that of the integrated circuit 40 in FIG. 4. The difference here is that there are totally (N/2) USB endpoints EP₀-EP_{(N/2-1)} included in the integrated circuit 80, wherein each USB endpoint is a transmitting and receiving endpoint (must have the “transmitting” and “receiving” functions at the same time). Therefore, the configuration unit 86 will respectively portion out two endpoint access units for the usage of each USB endpoint EP₀-EP_{(N/2-1)}. In this embodiment, the USB endpoint resource includes N endpoint access units, which is the case for supporting a minimum number of endpoints.

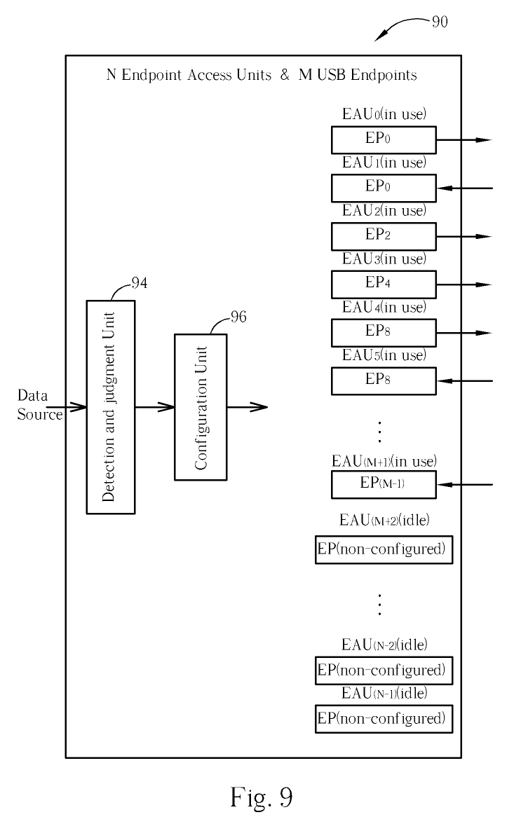

Please refer to FIG. 9. FIG. 9 is a diagram of an integrated circuit 90 for dynamically configuring the USB endpoint resource according to another embodiment of the present invention. The structure and the operating manner of the integrated circuit 90 are similar to that of the integrated circuit 40 in FIG. 4, the difference being that the numbers of the USB endpoints of the integrated circuit 90 are not continuous, wherein the endpoint EP₀ is sequentially followed by EP₄, EP₆, and EP₈ without EP₁-EP₃, EP₅, and EP₇. The first USB endpoint EP₀ is a transmitting and receiving endpoint, the USB endpoints EP₄ and EP₆ are each a transmitting endpoint, and the USB endpoint EP₈ is a transmitting and receiving endpoint, and so fourth. Therefore, the configuration unit 96 will portion out two endpoint access units EAU₀ and EAU₁ for the use of the first USB endpoint EP₀, the configuration unit 96 will respectively portion out the endpoint access units EAU₂ and EAU₃ for the usage of the USB endpoints EP₄ and EP₆, and the configuration unit 96 will portion out two endpoint access units EAU₄ and EAU₅ for the usage of the USB endpoint EP₈, and so fourth. As is known from this embodiment, through the detection and judgment unit 94 and the configuration of the configuration unit 96, a disclosed design of the present invention is still suitable for use although the numbers of the endpoints are not continuous.

Please note that, the manner that the configuration unit portions out the endpoint access units for the usage of each USB endpoint is divided into two cases, wherein the first case is where the endpoint access units are portioned out for the usage of each USB endpoint with continuous numbers (such as the embodiments in FIG. 5-FIG. 8) and the second case is that the endpoint access units are portioned out for the usage of each USB endpoint with discontinuous numbers (such as the embodiment in FIG. 9), which can be adjusted depending on user's demands.

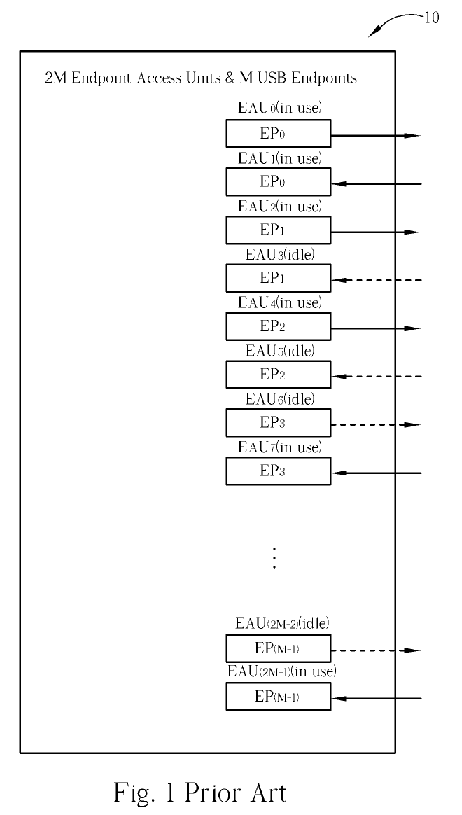

In the embodiments shown in FIG. 5-FIG. 9, although the total number of applied USB endpoints and the characteristics of each USB endpoint are different in each case, the same N endpoint access units EAU₀-EAU_{(N-1)} are provided for the usage of each USB endpoint. However, through the detection of the detection and judgment unit and the configuration of the configuration unit, the same integrated circuit can be suitable for different USB products, even when the products have the USB endpoints with discontinuous numbers, which will make the application of the integrated circuit more flexible. Although the application of the integrated circuit disclosed in the present invention are more flexible, only an appropriate number of USB endpoint resources is needed instead of twice the number of USB endpoints (such as the embodiment in FIG. 1). Therefore, no more excess IC area is wasted, which lowers the cost of the integrated circuit.

The abovementioned embodiments are presented merely for describing the present invention, and in no way should be considered to be limitations of the scope of the present invention. The abovementioned numbers N and M of the USB endpoints and the endpoint access units are not limited to a fixed value, and can be adjusted depending on user's demands. Each endpoint access unit can be used for transmitting data or receiving data, and is not limited to one of functions only. The integrated circuits 40-90 are merely embodiments for describing how to dynamically configuring USB (universal serial bus) endpoint resource of the invention and are not limited to them only; other applications also belong to the scope of the present invention. In addition, the sequence of the flow 30 is merely a preferred embodiment of the method of the present invention, wherein its sequence of the steps can be varied according to actual situations. For example, the step 306 can be divided into two steps: detecting the total number of the plurality of USB endpoints and detecting the characteristics of each USB endpoint. Please note that, the manner in which the configuration unit portions out the endpoint access units for the usage of each USB endpoint comprises two cases, wherein the first case is that the endpoint access units are portioned out for the usage of each USB endpoint with continuous numbers and the second case is that the endpoint access units are portioned out for the usage of each USB endpoint with discontinuous numbers, which can be adjusted depending on user's demands. Furthermore, the step of detecting the characteristics of each USB endpoint can be subdivided into detecting whether the USB endpoint is a transmitting endpoint, detecting whether the USB endpoint is a receiving endpoint, and detecting whether the USB endpoint is a transmitting and receiving endpoint.

In summary, the present invention provides a method and related integrated circuit for dynamically configuring USB endpoint resource. Due to the detection and judgment units 44-94 and the configuration of the configuration units 46-96, the same endpoint access units can be provided for the usage of the USB endpoints with different numbers and different characteristics. Therefore, the integrated circuit can be suitable for different USB products, even when the products have the USB endpoints with discontinuous numbers, which will make the applications of the integrated circuit more flexible. Because the present invention only needs to provide an appropriate number of USB endpoint resources, substantially no excess IC area is wasted, lowering the cost of the integrated circuit.

Those skilled in the art will readily observe that numerous modifications and alterations of the device and method may be made while retaining the teachings of the invention.

What is claimed is:

1. A method for dynamically configuring a USB (universal serial bus) endpoint resource comprising:
providing the USB endpoint resource, wherein the USB endpoint resource includes a plurality of endpoint access units;
detecting and determining a total number of a plurality of USB endpoints and characteristics of each USB endpoint; and
portioning out the plurality of endpoint access units for use by each USB endpoint, the portioning out according to the total number of the plurality of USB endpoints and the characteristics of each USB endpoint.

2. The method of claim 1, wherein each one of the endpoint access units is utilized for transmitting data or receiving data.

3. The method of claim 1, wherein the step of detecting and determining the characteristics of each USB endpoint comprises:
detecting and determining whether the USB endpoint is a transmitting endpoint.

4. The method of claim 3, wherein the step of portioning out the plurality of endpoint access units for use by each USB endpoint according to the total number of the plurality of USB endpoints and the characteristics of each USB endpoint comprises:
when the USB endpoint is a transmitting endpoint, portioning out one endpoint access unit for the use of the transmitting endpoint.

5. The method of claim 4, wherein the endpoint access unit portioned out to the transmitting endpoint is utilized for transmitting data.

6. The method of claim 1, wherein the step of detecting and determining the characteristics of each USB endpoint comprises:
detecting and determining whether the USB endpoint is a receiving endpoint.

7. The method of claim 6, wherein the step of portioning out the plurality of endpoint access units for use by each USB endpoint according to the total number of the plurality of USB endpoints and the characteristics of each USB endpoint comprises:
when the USB endpoint is a receiving endpoint, portioning out one endpoint access unit for the use of the receiving endpoint.

8. The method of claim 7, wherein the endpoint access unit portioned out to the receiving endpoint is utilized for receiving data.

9. The method of claim 1, wherein the step of detecting and determining the characteristics of each USB endpoint comprises:
detecting and determining whether the USB endpoint is a transmitting and receiving endpoint.

10. The method of claim 9, wherein the step of portioning out the plurality of endpoint access units for use by each USB endpoint according to the total number of the plurality of USB endpoints and the characteristics of each USB endpoint comprises:
when the USB endpoint is a transmitting and receiving endpoint, portioning out two endpoint access units for the use of the transmitting and receiving endpoint.

11. The method of claim 10, wherein one of the two endpoint access units portioned out to the transmitting and receiving endpoint is utilized for transmitting data, and the other one is utilized for receiving data.

12. The method of claim 1, wherein the step of portioning out the plurality of endpoint access units for use by each USB endpoint comprises:
portioning out the endpoint access units having continuous serial numbers for the use of each USB endpoint, or portioning out the endpoint access units having discontinuous serial numbers for the use of each USB endpoint.

13. An integrated circuit for dynamically configuring a USB endpoint resource, the integrated circuit comprising:
the USB endpoint resource comprising a plurality of endpoint access units, wherein each one of the endpoint access units is used for transmitting data and receiving data;
a detection and judgment unit, for detecting and determining a total number of a plurality of USB endpoints and characteristics of each USB endpoint; and
a configuration unit, coupled to the detection and judgment unit, for portioning out the plurality of endpoint access units for use by each USB endpoint according to the total number of the plurality of USB endpoints and the characteristics of each USB endpoint.

14. The integrated circuit of claim 13, wherein a data source of the detection and judgment unit is from an outside part of the integrated circuit.

15. The integrated circuit of claim 13, wherein when the detection and judgment unit judges that the USB endpoint is a transmitting endpoint, the configuration unit portions out one endpoint access unit for the use of the transmitting endpoint.

16. The integrated circuit of claim 15, wherein the endpoint access unit portioned out to the transmitting endpoint is utilized for transmitting data.

17. The integrated circuit of claim 13, wherein when the detection and judgment unit judges that the USB endpoint is a receiving endpoint, the configuration unit portions out one endpoint access unit for the use of the receiving endpoint.

18. The integrated circuit of claim 17, wherein the endpoint access unit portioned out to the receiving endpoint is utilized for receiving data.

19. The integrated circuit of claim 13, wherein when the detection and judgment unit judges that the USB endpoint is a transmitting and receiving endpoint, the configuration unit portions out two endpoint access units for the use of the transmitting and receiving endpoint.

20. The integrated circuit of claim 19, wherein one of the two endpoint access units portioned out to the transmitting and receiving endpoint is utilized for transmitting data, and an other one is utilized for receiving data.

21. The integrated circuit of claim 13, wherein:
the endpoint access units having continuous serial numbers are portioned out for the use of each USB endpoint; or
the endpoint access units having discontinuous serial numbers are portioned out for the use of each USB endpoint.
